(19) United States
(12) Patent Application Publication
(10) Pub. No.: US 2005/0137955 A1
(43) Pub. Date: Jun. 23, 2005

(54) Systems and methods for using a dedicated controller to facilitate foreign exchange pricing

(76) Inventors: Alan D. Downie, Bayswater (GB); Daks Kotecha, Kingsbury London (GB); Suzanne Lesley Hubble, Islington London (GB); Scott Gallopo, Montville, NJ (US); Nick Munns, Orpington (GB); Iain Doran, Sevenoaks Kent (GB); Matthew Forsyth, Southfield (GB); Celia Wenban-Smith, London (GB); Stephen Flanagan, Lynbrook, NY (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 10/895,003

(22) Filed: Jul. 20, 2004

Related U.S. Application Data
(60) Provisional application No. 60/530,287, filed on Dec. 17, 2003.

(51) Int. Cl. G06F 17/60

(52) U.S. Cl. 705/36; 705/37

(57) ABSTRACT

A foreign exchange pricing system includes a computer system executing a foreign exchange pricing application, the foreign exchange pricing application capable of displaying foreign exchange pricing information. A dedicated controller, including a joystick, is operatively coupled to the computer system. A user can employ the joystick to display or alter the pricing information. Preferably, the dedicated controller includes a combination of a keyboard and the joystick. The displayed pricing information will preferably relate to either spot rates or forward rates. The foreign exchange pricing system can determine that the joystick has moved in a certain position to invoke a specified procedure. For example, the invoked procedure might perform setting a bid price, setting an ask price, publishing a bid and an ask price, resetting entered information, setting a minimum spread, setting a maximum spread, setting a normal spread, publishing spread control information, setting a skew, publishing skew control information, or setting status control information.

### CROSS REFERENCE TO RELATED APPLICATIONS

This application claims the benefit of U.S. Provisional Application Ser. No. 60/530,287, filed by Downie et al. on Dec. 16, 2003 and entitled “Systems and Methods For Using a Dedicated Controller to Facilitate Foreign Exchange Pricing”, which is incorporated herein by reference.

### FIELD OF THE INVENTION

The present invention relates generally to the use of specialized computing devices, and, more particularly, to the use of a dedicated controller to facilitate pricing in the foreign exchange market.

### BACKGROUND OF THE INVENTION

The foreign exchange market enables companies, fund managers and banks to buy and sell foreign currencies, if necessary in large amounts. The motivations behind this demand for foreign currency include capital flows arising from trade in goods and services, cross-border investment and loans and speculation on the future level of exchange rates. The sums involved are very large: estimated global turnover in all currencies in April 1998 was $1,490 billion, an increase of 26 percent over the past three years. Deals are typically for amounts between $3 million and $10 million, though much larger transactions are often done.

Foreign exchange trading may be for spot or forward delivery. Generally, spot transactions are undertaken for an actual exchange of currencies (delivery or settlement) two business days later (the value date). Forward transactions involve a delivery date further into the future, possibly as far as a year or more ahead. By buying or selling in the forward market a bank can, on its own behalf or that of a customer, protect the value of anticipated flows of foreign currency, in terms of its domestic currency, from exchange rate volatility.

Unlike some financial markets, the foreign exchange market has no single location—foreign exchange is not dealt across a trading floor. Instead, trading is via telephone and computer links between dealers in different centers and, indeed, different continents. London is the world's largest foreign exchange center: average daily turnover is $637 billion. This is approximately the same as the combined level of trading in the United States, Japan and Singapore.

Because of the fast-moving nature of the foreign exchange markets, it is clear that traders require fast, accurate and flexible controls over foreign exchange prices. Currently, traders utilize a number of technologies which allow clients to trade foreign exchange deals without any intervention from a salesperson or trader. The ability of traders to monitor and control these prices is vitally important.

### SUMMARY OF THE INVENTION

A foreign exchange pricing system includes a computer system executing a foreign exchange pricing application, the foreign exchange pricing application capable of providing foreign exchange pricing information. A dedicated controller, including a joystick, is operatively coupled to the computer system. A user can employ the joystick to display or alter the pricing information. Preferably, the dedicated controller includes a combination of a keyboard and the joystick.

In an embodiment, the displayed pricing information relates to either spot rates or forward rates. The foreign exchange pricing system can determine that the joystick has moved in a certain position to invoke a specified procedure. For example, the procedure might perform setting a bid price, setting an ask price, publishing a bid and an ask price, resetting entered information, setting a minimum spread, setting a maximum spread, setting a normal spread, publishing spread control information, setting a skew, publishing skew control information, setting status control information, and so forth.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 depicts an exemplary screen for a foreign exchange pricing application;

FIGS. 2(a) and (b) depict an exemplary dedicated controller which can be used for foreign exchange pricing; and

FIG. 3 depicts a block diagram of an exemplary foreign exchange pricing system using the dedicated controller.

### DESCRIPTION OF PREFERRED EMBODIMENTS

The present invention provides a dedicated controller to facilitate foreign exchange pricing. The dedicated controller includes a joystick that can be used in conjunction with a keyboard. A foreign exchange pricing system includes a computer system executing a foreign exchange pricing application, the foreign exchange pricing application capable of providing foreign exchange pricing information. The dedicated controller, including the joystick, is operatively coupled to the computer system. A user can employ the joystick to display or alter the pricing information.

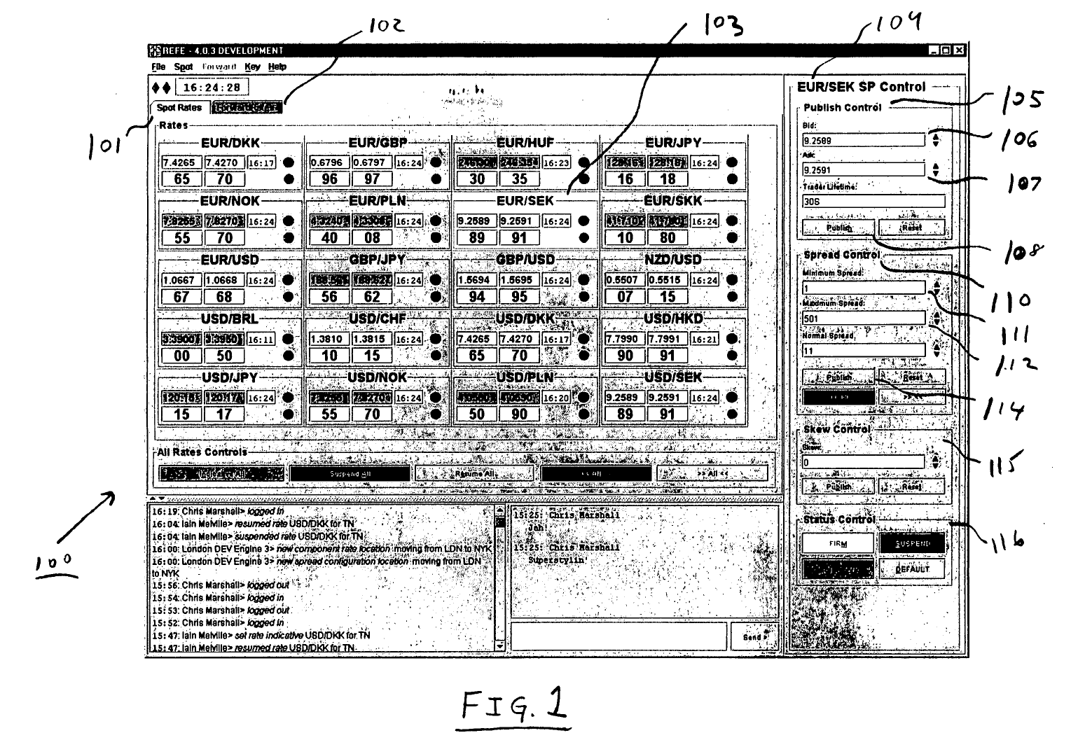

Referring to FIG. 1, a typical screen 100 for trading foreign currency is illustrated. This screen 100 includes the option of either displaying spot rates or forward rates. A tab 101 can be selected to display spot rates (as shown); alternatively, a tab 102 can be selected to display forward rates. Although the examples provided herein refer to spot rates, it is to be appreciated that the present invention also applies to forward rates. It is to be appreciated that the screen 100 is shown for illustrative purposes.

To execute a spot deal in the market, typically a dealer contacts his counterpart at a market-making bank and asks for the price in, for example “Euro-Kronor” (i.e., EURO to the Sweden Kronor). The market maker normally quotes a two-way price—that is, he stands ready to bid for or offer up to some standard amount. The difference between these two prices is known as the spread. For the sake of convenience, the market convention where trading is between banks is not to quote the “big figures”; instead, dealers tend to quote only the points (the last two figures of the price). As shown in box 103, for example, if the rate for Euros (EUR) against the Sweden Kronor (SEK) was [symbol] =SEK 9.2589-91, then the market maker would quote “eighty-nine to ninety-one”: he bids for Kronor at [symbol] 9.2589 and offers them at [symbol] 9.2589. If the market maker wishes to deal he will hit, that is accept, one side of the price. Written confirmation of this contract will be exchanged and instructions concerning payment given, and passed on to the settlements staff who ensure that the respective currency amounts are transferred into the designated accounts on the value date.

In addition to displaying foreign exchange rates, the exemplary screen 100 can also allow the user to alter them. For example, if the market maker wished to alter the current rates for EUR/SEK, he would select box 103, for the EUR/SEK rate, then enter the new rate in the Rate Display window 104. The Rate Display window 104 contains information about spreads/skews and allows the user to alter these values and control the status of the rate. As implemented, this exemplary “child window” can be “docked” to the main window, or given focus, by pressing an appropriate combination of short-cut keys. As shown in FIG. 1, the Rate Display window 104 is docked.

As illustrated in FIG. 1, the Rate Display window 104 allows the user to enter a “bid” value into box 106, an “ask” value into box 107, and to publish this information by selecting button 108. The Spread Control function 110 allows the user to set minimum, maximum and normal spreads on a rate, using boxes 110, 111, and 112, respectively. This spread information can be published by selecting button 114. Additional features of the Rates Display window 104 include skew control 115 to allow the user to skew the published rate in either direction. For example, the user might apply a skew of 1.5 to the rate (i.e., skew the mid-points downwards by one and a half pips). Additionally, a status control feature 116 can be used to enable the user to control the selected rate on the underlying pricing engine. As shown rate status can include “firm”, “indicative”, “suspend”, and “default”.

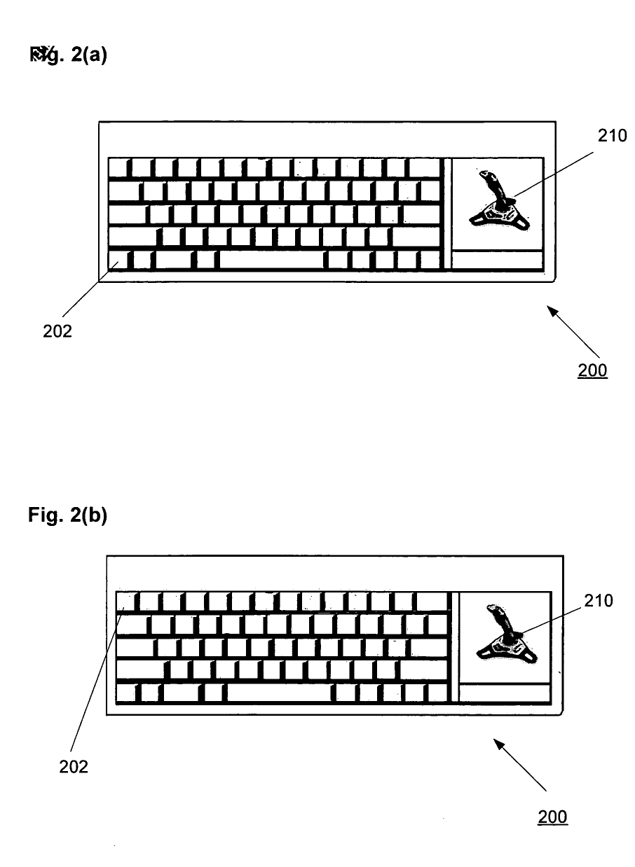

FIGS. 2(a) and (b) illustrate an exemplary dedicated controller 200 which can be used to for controlling a foreign exchange system such as the one described above. In the embodiment depicted in FIGS. 2(a) and (b), the dedicated controller 200 comprises a combination keyboard 202 and a joystick 210. The keyboard 202 can include a conventional keyboard. It may also feature additional special-purpose keys. However, the main focus of the present invention is the use of the joystick 204 for the purposes of quickly manipulating pricing information.

In general, a joystick is an input device that provides positional information to an application program. Typically, a joystick also includes one or more button for additional input. The joystick operates within a two- or three-axis coordinate system. Most operating systems, such as MICROSOFT WINDOWS, UNIX, and LINUX, provide joystick services that are loaded when the operating system is started.

An application program can query the current position of the joystick and/or whether its button(s) are depressed. For example, in the MICROSOFT WINDOWS environment, an application program may use the joyGetPos function to query a joystick for its position and button status. This function returns a pointer to a structure JOYINFO which appears as follows:

Typedef struct {

UINT wXpos;
UINT wYpos;
UINT wZpos;
UINT wButtons;
} JOYINFO;

where the values wXpos, wYpos, and wZpos return the current X, Y, and Z values, respectively. The values for each of the joystick buttons can be obtained from the wButtons structure (e.g., JOY_BUTTON1, JOY_BUTTON2).

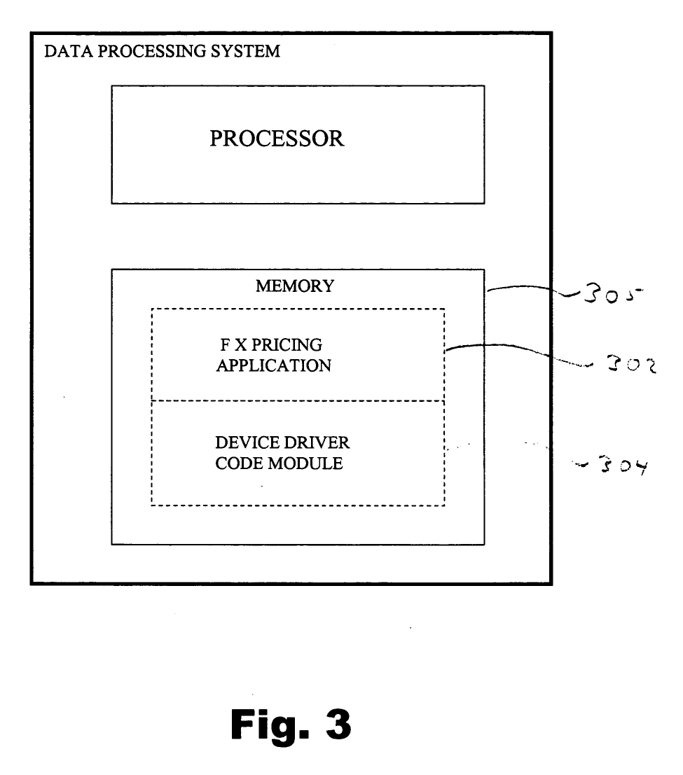

Referring to FIG. 3, a block diagram of software components of the system described above are illustrated. As depicted in this simplified diagram, a memory area 305 includes a Foreign Exchange Pricing Application 302 and a Device Driver Code Module 304. The Foreign Exchange Pricing Application 302 could include the foreign exchange trading application described with respect to FIG. 1, or another such trading application. The Foreign Exchange Pricing Application 302 can interact with a Device Driver Code Module 304, or with the operating system directly, to obtain joystick parameters and status information.

The invention will be clarified by the following example.

### EXAMPLE 1

Table 1 illustrates various exemplary joystick positions to control a foreign exchange application. It is to be appreciated that the following is provided for illustrative purposes.

As shown in Table 1, when the joystick 204 is in the (0,1) position, the mid-price is moved upward. When the joystick 204 is in the (0,−1) position, the mid-price down is moved downward. A joystick 204 position of (1,0) causes the offer rate to be moved upward. A joystick 204 position of (−1,0) causes the bid rate down to be moved downward. It is also possible to employ button information. A joystick 204 is in the (1,0) position with the button is pressed causes the bid/ask spread to widen. In this case, the bid is decreased, the offer is increased, and the midpoint is maintained. A joystick 204 is in the (−1,0) position with the button is pressed causes the bid/ask spread to widen. In this case, the bid is decreased, the offer is increased, and the midpoint is maintained.

TABLE 1

| Joystick Position | Function |
|---|---|
| X = 0, Y = 1 | PUSH MID-PRICE UP (NO SPREAD |
| | CHANGE) |
| X = 0, Y = −1 | PUSH MID-PRICE DOWN UP (NO |
| | SPREAD CHANGE) |
| X = 1, Y = 0 | PUSH OFFER RATE UP (WIDEN |
| | SPREAD IN OFFER DIRECTION) |
| X = −1, Y = 0 | PUSH BID RATE DOWN (WIDDEN |
| | SPREAD IN BID DIRECTION) |
| X = 1, Y = 0, BUTTON 1 | WIDEN SPREAD |
| X = 1, Y = 0, BUTTON 1 | NARROW SPREAD |

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

1. A foreign exchange pricing system, comprising:
a computer system executing a foreign exchange pricing application, the foreign exchange pricing application for providing foreign exchange pricing information; and
a dedicated controller, including a joystick, operatively coupled to the computer system, the joystick for altering the pricing information.

2. The foreign exchange pricing system of claim 1, wherein the dedicated controller includes a combination of a keyboard and the joystick.

3. The foreign exchange pricing system of claim 1, wherein the displayed pricing information relates to one of spot rates and forward rates.

4. The foreign exchange pricing system of claim 1, wherein a movement of the joystick causes a procedure to be invoked.

5. The foreign exchange pricing system of claim 1, wherein the joystick is other than a pointing device.

6. The foreign exchange pricing system of claim 1, wherein a movement of the joystick has a corresponding coordinate value.

7. The foreign exchange pricing system of claim 1, wherein one or more joystick buttons are used to perform specified functions.

8. A method for using a dedicated controller to facilitate foreign exchange pricing, the dedicated controller including a joystick coupled to a computer system, the computer system executing a foreign exchange pricing application, comprising the steps of:
displaying foreign exchange pricing information; and
using the joystick device to alter the pricing information.

9. The method of claim 8, wherein the dedicated controller includes a combination of a keyboard and the joystick.

10. The method of claim 8, wherein the displayed pricing information relates to one of spot rates and forward rates.

11. The method of claim 8, wherein a movement of the joystick causes a procedure to be invoked.

12. The method of claim 8, wherein the joystick is other than a pointing device.

13. The method of claim 8, wherein a movement of the joystick has a corresponding coordinate value.

14. The method of claim 8, wherein one or more joystick buttons are used to perform specified functions.

15. A program storage device readable by a machine, tangibly embodying a program of instructions executable on the machine to perform method steps for using a dedicated controller to facilitate foreign exchange pricing, the dedicated controller including a joystick coupled to a computer system, the computer system executing a foreign exchange pricing application, the method steps comprising:
displaying foreign exchange pricing information; and
using the joystick device to alter the pricing information.
